(19) United States
(12) Patent Application Publication
(10) Pub. No.: US 2005/0227792 A1
(43) Pub. Date: Oct. 13, 2005

(54) Virtual golf training and gaming system and method

(75) Inventors: Iain McCreary, Tuscon, AZ (US); Phil McLachlan, Aberdeenshire (GB); John Kellett, Hertfordshire (GB)

Correspondence Address: DARBY & DARBY P.C., P. O. BOX 5257, NEW YORK, NY, 10150-5257, US

(73) Assignee: HBL Ltd., London (GB)

(21) Appl. No.: 11/082,744

(22) Filed: Mar. 17, 2005

Related U.S. Application Data
(60) Provisional application No. 60/554,539, filed on Mar. 18, 2004.

(51) Int. Cl. A63B 57/00

(52) U.S. Cl. 473/409

(57) ABSTRACT

A virtual golf training and gaming system and method are disclosed. According to one aspect of the invention, real-time shot information obtained from a trackable golf ball is compared with and used to determine a correlation with one or more training shots displayed to a golfer over a display, and wherein the correlation is used to provide training advice and assistance to the golfer. According to another aspect of the invention, the real-time shot information is converted into one or more game parameters which can then be used within the game environment of a virtual game. According to yet another aspect of the invention, the real-time shot information is used to determine an initial shot location for a golf shot and to identify the golfer based on the initial shot location, and this identification can be used in connection with the virtual training and/or gaming system and method.

### FIELD OF THE INVENTION

The present invention is directed to a virtual golf training and gaming system and method. One aspect of the invention is directed to a method and a system that uses real-time shot information, such as the location or trajectory of a golf ball, to provide training advice and assistance to a golfer. Another aspect of the invention is directed to a method and a system that converts such real-time information into a game parameter which can then be used within a game environment of a virtual game.

### BACKGROUND OF THE INVENTION

Various types of golf training and gaming systems exist. As discussed below, all are limited in that they do not account for real-time information about a golf shot taken by the golfer. None can realistically be used within a driving range environment. Real-time information may include, for example, information such as the initial and final ball location, ball distance, initial and average ball speed, maximum height, ball spin, distance traveled while in air, bouncing or rolling, launch angle, etc. Real-time information about a golf ball includes information that is obtained from a golf ball itself. Importantly, this information does not immediately need to be relayed, and can be stored in a memory for later use, and still be considered real-time information. The various prior art systems and their limitations are discussed below.

Golf Training Systems:

Various types of golf training systems are known. They range from putting and driving simulators that provide no guidance to the user other than what the user can discern himself, to more elaborate computerized video-based tracking systems. Almost all these systems are limited in that they do not utilize real-time information about a golf shot taken by the golfer when providing guidance and advice.

Those training systems that can account for certain aspects of a golf shot typically look only at the golfer's swing and club motion, rather than the actual golf ball hit by the golfer. These systems are generally video based tracking systems, which are typically used for training at driving ranges and other golf centers. Video based systems generally record all aspects of the swing, such that various swing parameters, including stroke angle and club-head speed can be calculated. These systems generally provide no information about an actual shot. They also do not provide actual ball location information, only estimated shot distance information based on the calculated parameters. These systems also require extensive interaction with the monitoring system so that the information. is accurately captured and recorded. Further, they require expensive and bulky equipment and often require human intervention in order for the golf shot information to be translated into any type of practical guidance for the golfer.

Golf Gaming Systems:

Various types of golf gaming systems also currently exist. Such systems range from golf games for video game systems and personal computers, to arcade games, to more extensive virtual golf gaming systems that are often found in arcades and malls. Golf games for video game systems and personal computers typically require little user physical action, other than through interaction with the joystick or keyboard operating the game. Arcade golf games are similar in that, they too, typically require no physical action by the player. All these systems do not account for real-time information on a golf swing and/or golf ball hit by the player within the game environment.

Certain more elaborate virtual golf gaming systems have also been developed. Most are found in arcades and/or mall environments. These systems generally include a mat on which a golf ball is placed. A player is given a golf club with which he or she can hit the ball. In front of the player is a virtual display of a hole on a golf course. Video cameras and various monitoring equipment is utilized to track the golfer's swing. After the golf shot is taken, the video footage of the swing is analyzed by a computer system, which then converts this information into a theorized golf shot. This shot is displayed within the virtual display so that the player can see an example of the type of shot that may have resulted. A player continues taking shots on a displayed hole until he or she quits, or the ball reaches the cup on that hole, at which time the player can continue to the next hole.

An improvement of these systems encompasses the more complex indoor driving range simulator systems. In such systems, the golfer hits the ball off a mat toward a wall sized screen and the balls trajectory is estimated. After being struck, the ball typically passes through two or more planes with photoreceptor cells. These planes give a two dimensional X-Y position as the ball passes through the plane. Ball speed and launch angle can be calculated by assuming a linear trajectory between the two or more measured positions. Ball spin may also be inferred based on how the ball bounces off the screen.

Importantly, the shot displayed for these systems is only theoretical—it is not based on actual real-world information obtained from the golf ball's actual full flight and landing, including bouncing and rolling. It is only an estimation of the actual shot that the player would have hit. Further, these systems only allow the user to play a round of golf within the particular golf courses stored within the computer system. They do not allow the golfer's shot information to be converted for use within other types of games.

Driving Range Applications:

None of the aforementioned systems can be used to track real-time golf shot information on a shot hit by a golfer within a driving range environment. For example, Topgolf, along with their parent company World Golf Systems and its subsidiary Baydrive Ltd., allege on their website (www.topgolf.co.uk) to operate a series of driving ranges incorporating RFID (radio frequency identification) technology. These systems allegedly use golf balls having an implanted micro-chip (the RFID tag) in the ball and sensors on the course to identify when the balls land in the particular areas of the course where the sensor mats are located. In this way, if the ball lands in a target location housing the sensors, the total distance of the shot can be calculated. This distance information is not known to be used within a training and/or gaming environment. Further, this system lacks the ability to distinguish between an accurate, aimed shot that lands in a target area and a wide, random shot. More importantly, the system cannot be used to obtain real-time information about a ball in motion, nor can it be used if the ball doesn't land in one of the target locations.

### SUMMARY OF THE INVENTION

One embodiment of the present invention is directed to a method of providing training advice to a golfer who is using a trackable golf ball, the method comprising the steps of: providing a training device which includes a receiver, a processor, a memory and a display; displaying information concerning a training shot to the golfer using the display; receiving real-time shot information at the receiver concerning a shot by the golfer using the trackable golf ball; comparing the shot information and the training shot using the processor to determine a correlation between the shot information and the training shot; displaying the shot information together with the correlation to the golfer on the display.

Another embodiment of the present invention is directed to a method of employing real-time shot information on a golf shot hit by a golfer using a trackable golf ball within a virtual game, the method comprising the steps of: providing a gaming system having a processor, a display and a receiver; displaying a game environment for the virtual game to the golfer on the display; receiving the real-time shot information concerning the golf shot using the receiver; processing the shot information using the processor to determine one or more game parameters; utilizing the game parameters within the virtual game and updating the game environment based on the game parameters.

Another embodiment of the present invention is directed to a method of tracking an initial shot location of a golf shot made by a golfer at a driving range using a trackable golf ball, the method comprising the steps of: providing a receiver, a processor coupled to the receiver, and a memory coupled to the processor, the memory further storing information on the driving range; receiving real-time shot information transmitted from an ultra-wideband transmitter embedded in the golf ball using the receiver; and comparing the shot information with the information on the driving range using the processor to determine the initial shot location.

Another embodiment of the present invention is directed to a virtual golf gaming system which utilizes real-time shot information on a golf shot hit by a golfer, the system comprising: a trackable golf ball having an embedded ultra-wideband transmitter for transmitting the shot information on the golf shot; a receiver configured to receive the shot information in substantially real time; a processor coupled to the receiver and configured to process the shot information to determine one or more game parameters for use within a virtual game, the virtual game stored within a memory connected to the processor, the processor further configured to provide at least an initial game environment for the virtual game and an updated game environment for the virtual game using the one or more game parameters; and a display operatively coupled to the processor so as to display at least the initial game environment and the updated game environment.

Yet another embodiment of the present invention is directed to a virtual golf training system which utilizes real-time shot information on a golf shot hit by a golfer, the system comprising: a trackable golf ball having an embedded ultra-wideband transmitter for transmitting the shot information on the golf shot; a receiver configured to receive the shot information in substantially real time; a processor coupled to the receiver and configured to provide one or more training shots, the one or more training shots stored within a memory connected to the processor, the processor further configured to compare the shot information and the one or more training shots to determine a correlation between the shot information and the one or more training shots; and a display operatively coupled to the processor so as to display at least the one or more training shots, the shot information and the correlation.

### BRIEF DESCRIPTION OF THE DRAWINGS

A preferred embodiment of the invention as well as alternate embodiments are described by way of example with reference to the accompanying drawings in which like numbers correspond to like elements, and in which:

FIG. 1 is an internal perspective view of a golf ball which can be used with the present invention;

FIG. 2 is a perspective view of a sensor which can be used with the present invention;

FIG. 3a is a front view of a preferred display for use with the present invention;

FIG. 3b is a front view of a portable handset for use with the present invention;

FIG. 4 is an internal perspective view of driving range with which present invention can be used;

FIG. 5 is a view of a display illustrating a first virtual game according to an aspect of the present invention;

FIG. 6 is a view of a display illustrating a second virtual game according to an aspect of the present invention;

FIG. 7 is a view of a display illustrating a third virtual game according to an aspect of the present invention;

FIG. 8 is a view of a display illustrating a fourth virtual game according to an aspect of the present invention;

FIG. 9 is a view of a display illustrating a fifth virtual game according to an aspect of the present invention;

FIG. 10 is a flow chart illustrating a virtual training method according to an aspect of the present invention;

FIG. 11 is a flow chart illustrating a method for determining the origin of a golf shot and the identity of a golfer making the shot according to an aspect of the present invention; and

FIG. 12 is a flow chart illustrating a golf gaming method according to an aspect of the present invention.

### DETAILED DESCRIPTION OF THE PREFERRED EMBODIMENTS

The following description is provided to enable those skilled in the art to make and use the present invention and sets forth the best mode contemplated by the inventors for carrying out their invention. Various modifications will be readily apparent to those skilled in the art and this invention may be embodied in many different forms and should not be construed as limited to the embodiments set forth herein. Thus, these embodiments are provided by way of example only.

Core Equipment:

The virtual golf training system utilizes real-time (or substantially real-time) information on a golf ball hit by a golfer. This information is compared with and used to determine a correlation with one or more training shots previously displayed to a golfer, and the correlation is used to provide training advice and assistance to the golfer. The virtual golf gaming system also utilizes the real-time shot information, but converts this information into one or more game parameters which can then be used within the game environment of a virtual game that is displayed to the golfer. In either system, according to one aspect of the invention, the real-time shot information can be used to determine an initial shot location for a golf shot and to identify the golfer based on the initial shot location. The real-time information used in any of these systems can be obtained using a variety of different technologies. Regardless of which type of technology is utilized, the systems preferably include the following core technology: (1) transmitting ball; (2) sensors/receivers; (3) display; and (4) server/processor.

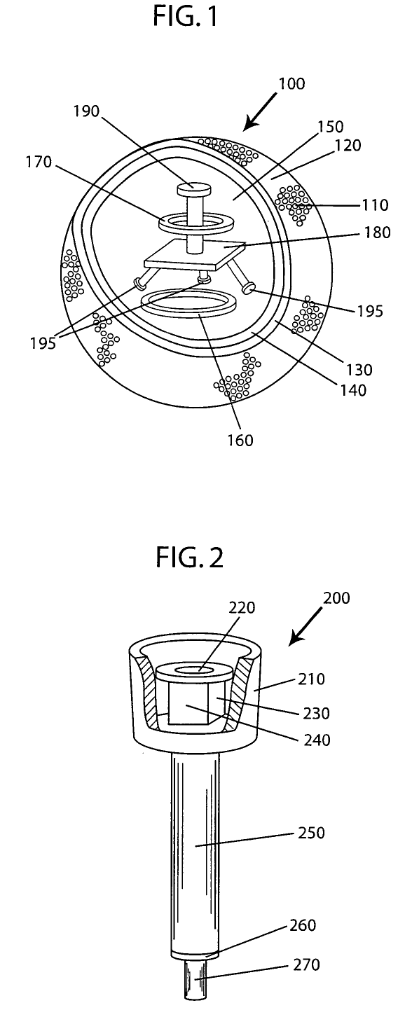

The present invention can be used with golf balls having an embedded active transmitter or a embedded dual transmitter/receiver. With the latter, the balls can receive information, as well as transmit information. A sample ball is shown in FIG. 1. As shown, the ball 100 includes a outer soft surlyn or balata cover 120 having multiple dimples 110 to provide better flight performance. The outer cover 120 surrounds a second layer 130 of polybutadiene rubber or TPE mixed with stiffeners such as tungsten or other metal powders. The second layer 130 surrounds a third inner core layer 140 that includes polybutadiene or another polymer doped to alter the compression characteristics and the elastic modulus, which dopants may include metals such as titanium powder or low density polmers. The third layer 140 surrounds a polymer core 150 that includes the components used with the present system. While the components are preferably contained within the inner core 150, one or more components may be embedded within the other layers. Additionally, while the ball has been described having four layers, balls having any number of layers may be used herewith.

The embedded components may include one or more counter weights 190 or low density spaces to help balance the weight and moments in the core and to ensure proper flight characteristics, a transmit antennae 170, a secondary antennae 160, a control stack including the electronic circuitry 180, and a power source, such as battery cells 195. Other components, such as an accelerometer or gyroscope (not shown), may also be included. The power source 195 may include rechargeable lithium cells, any type of non-rechargeable batteries, capacitors or part of an impact powered piezoelectric system. Also, the ball may be designed to transmit information constantly, or it may be activated so that it only transmits for shorter, discrete periods of times (e.g., 10 seconds).

The balls are preferably used in conjunction with one or more sensors/receivers such that real-time data about the position and flight characteristics of the ball can be received. The transmissions from the ball can be passed to sensors, which can be used individually or in a network, and can receive either a directional or a time differential signal from the balls. The sensors may also be incorporated directly within the server/processor described below. Possible transmitter/receiver technologies include active radio transmissions of any frequency and power, such as microwave ISM, infrared Bluetooth, GPRS, WiMAX, WiFi and ultra-wideband (“UWB”). Additional possibilities include passive or indirect transmissions and position determining systems, such as RFID, GPS, etc. While a variety of technologies can be used to track the ball in real-time, it is important that each ball can be uniquely identified so that its position can be individually tracked over time. For example, if the ball uses an active broadcast technology (such as UWB) each ball can broadcast a unique identification number or code.

Since the technology described herein is preferably used at a driving range, multiple sensors/receivers are preferably utilized around the range. Alternatively, the technology can be used on a golf course and multiple sensors/receivers can be used on each hole of the course. A sample complex sensor is shown in FIG. 2. The illustrated sensor 200 includes an outer framework 210 that houses an antennae 220 for receiving the transmissions, control electronics 230, and a power cell 240. Instead of using a battery 240, the sensors can alternatively be wired for power. The framework 210 can be connected to a support leg 250, which can be further connected to a threaded base post 270 using a weather seal 260. In this way, the sensors 200 can be firmly and securely mounted in the ground. Alternatively, a much simpler antennae, such as a standard dipole, can be used as the receiver. The choice and complexity of the receiver or antennae array is primarily determined by the choice of transmitter technology.

Using the signals transmitted from a ball to a sensor, the ball's position and/or flight characteristics can be determined. This can be accomplished using a server/processor (not shown) which can determine the ball position/attitude/trajectory from the raw data transmitted by the transmitter in the ball and information on the terrain over which the ball is traveling. One way the position data and flight characteristics can be obtained is through the use of the inventive methods disclosed in applicants' co-pending application entitled Method of Determining Flight Trajectory and Extracting Flight Data for a Trackable Golf Ball, the disclosure of which is incorporated herein by reference.

The server/processor also may contain the software used to provide the gaming and training functions of the present invention. One server/processor may be provided for an entire driving range (or golf course) or multiple servers/processors may be provided (such as one in each hitting bay of a driving range). As described above, the server/processor may also include the sensor/receiver.

A directional signal can use differentials in lobe power to determine the ball's location, such as is common in mobile telephone masts, or it can use a phased array or rotating antennae that selects the angle of maximum flux though the antennae to determine position. The server/processor can use that directional information from two or more antennae to triangulate the ball's position in space, using either fixed lobe or a phased array detection scheme. In a time differential system (such as could be used with UWB or microwave), signals from a ball would arrive at the sensors/antennae at different times, allowing the position of the ball to be calculated by a server/processor. Whichever configuration is used for the server/processor, one purpose of the server/processor is to process data from the sensors and balls so that ball's position and flight characteristics can be determined. Data for the ball can include: shot start position; initial velocity; initial launch angle; maximum height; distance in air; time in air; ball spin rate; number of bounces; bounce distance; bounce height; roll distance; shot end position; overall distance; shot deviation from straight line; and shot trajectory.

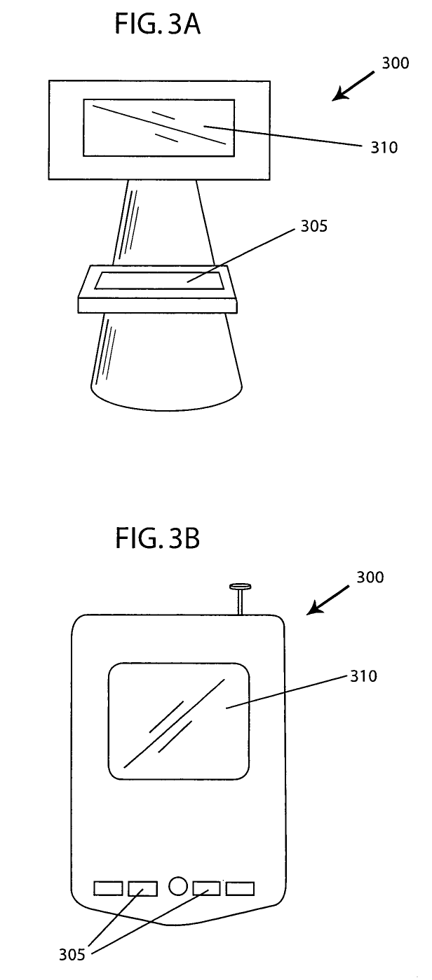

The term “display” is used herein to describe generally any type of data display device. The display may be a stand alone or wall-mounted display contained within each hitting location of a driving range, or it may be a portable handset/display which may be carried around by the user. An example of a stand-alone display is shown in FIG. 3a and an example of a portable display is shown in FIG. 3b. As shown in both FIG. 3a and FIG. 3b, the display 300 preferably includes a display screen 310 and a data entry system, such as a keyboard or data entry keys 305.

Use of Core Equipment at a Driving Range:

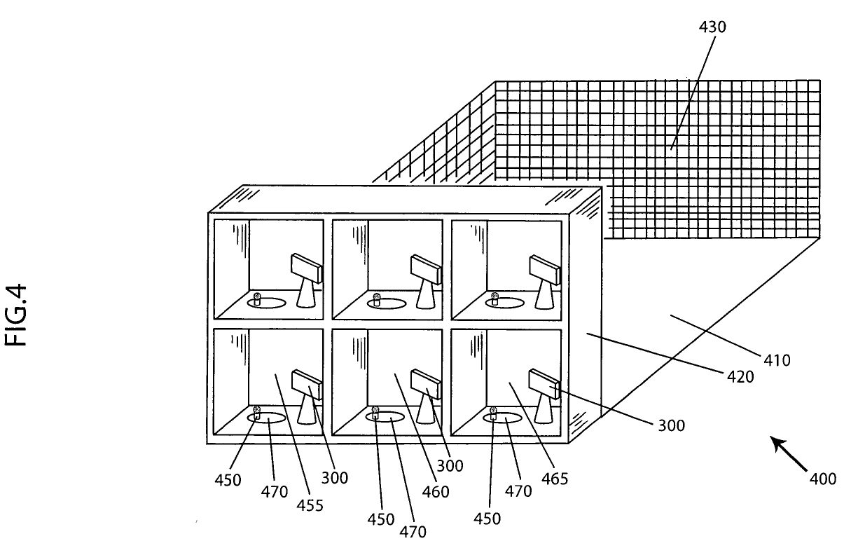

An example of a driving range 400 at which the present invention may be used is shown in FIG. 4. As illustrated, the driving range may include a multiple level hitting area 420, each level having multiple hitting bays (e.g., 455, 460, 465) from which a golfer can take shots. Each hitting bay 455, 460, 465 typically includes a tee 450, to which balls can be continuously fed to the golfer from a ball dispenser (not shown), and a mat 470 on which the golfer stands to line up and take the shot. Each bay 455, 460, 465 preferably includes its own stand-alone or wall mounted display 300. From the hitting bay, the golfer takes a golf shot and the ball travels onto the driving range area 410. The driving range area 410 may include nets 430 which surround the sides and back of the driving range 400 to minimize ball loss and to aid in ball collection. Typically, at periodic intervals, the balls are collected, either manually or by some type of automatic ball collection device .

Using the core equipment, the trajectory or track of each ball that is struck by a golfer can be captured and displayed to the golfer over the display 300. In this way, benefits are provided to not only the golfer, who can see and better understand his own shots, but also to the driving range, which can operate at night without the need for extensive lighting to illuminate the course and physical targets thereon. As a result, light pollution resulting from such driving ranges at night can be minimized.

Preferably, when used at a driving range, the trackable balls 100 used with the present invention include an embedded accelerometer or gyroscope (not shown) that would activate the signal transmitter when the ball was struck with a sufficient amount of force (i.e., with a club). Additionally, the transmitter would preferably remain active only for a small period of time (e.g., 10 seconds). In this way, the shot could be tracked in its entirety, but the receiver system would not be overwhelmed with signals from hundreds of balls transmitting simultaneously and constantly within a small area. Preferably, the signal transmission for a particular golf ball would begin when the ball is struck by the golfer and the signal would end after a discrete period of time, such as 10 seconds. Alternatively, the signal transmission may cease when the acceleration or deceleration stops, thereby indicating that the ball has come to rest.

By using this acceleration information, the start and stop of the ball's track can be marked. If an accelerometer or gyroscope is embedded in the trackable ball 100, the acceleration information can be directly transmitted to the receiver 200 and the server/processor. Alternatively, the processor can calculate this information using the location (e.g., distance) and time of flight information for the golf shot.

When used at a driving range, the trackable balls 100 need not be linked or associated with a particular user before use (such as by the operator scanning an identification tag on or inside of the ball before use and manually or automatically entering the association with a particular golfer into the processor). Nevertheless, the ball's real-time information is still preferably associated with a particular location on the driving range. The system can decide on which display 300 to display the golfer shot information based on the start position for the shot trajectory. If the user has not registered with the driving range, the shot information can be saved in an anonymous user data file marked with the position of the riving range, the date and the time. However, if the user has registered with the driving range (such as by entering in his identity through the display keypad 305), the shot information can be linked with that particular user and can be permanently stored in the user's personal data file such that it can be accessed by the user at later visits.

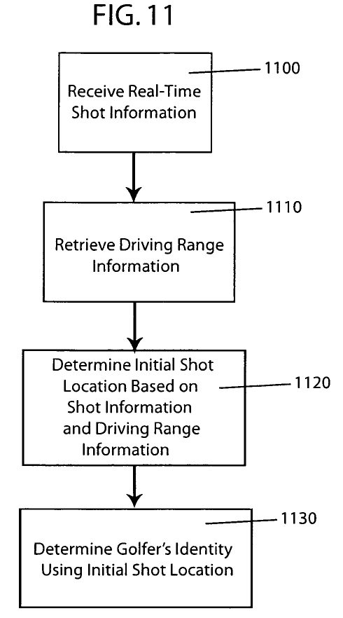

A preferred method for associating a golf shot with a particular location (e.g., hitting bay or booth) on a driving range is illustrated in FIG. 11. When a ball 100 is struck by the golfer, the ball 100 transmits the flight information in substantially real time to the sensor/receiver 200, which passes this information on to the server/processor at step S1100. At step S1110, the processor retrieves various information on the driving range from a memory location or data file. This information preferably includes the exact location of each hitting bay on the driving range. At step S1120, the processor analyzes the real-time shot information and the driving range information and determines an initial shot location on the driving range. In this way, the shot information can be associated with a particular hitting bay on the driving range. Further, the shot information can be displayed only on the display 300 at that particular hitting bay. Additionally, if the particular golfer has registered his identity with the driving range, at step S1130, the golfer's shot information can be associated with that golfer. Additional information on the shot can be manually entered by the user at his hitting bay location using the keyboard 305. This information may include information such as club type, weather conditions, etc. Alternatively, club type may be automatically sensed by the system and associated with a hitting location where an identification tag or transmitter is included on the golf club, and weather conditions may also be independently determined and accounted for using known methods.

Virtual Gaming System and Method:

In addition to basic shot display, the core technology can enable a golfer to engage in a number of gaming activities while on a driving range. These games leverage the system's ability to track a golf ball in flight and to associate the real-time information from the trackable golf ball with a particular location (and thereby golfer) on the driving range.

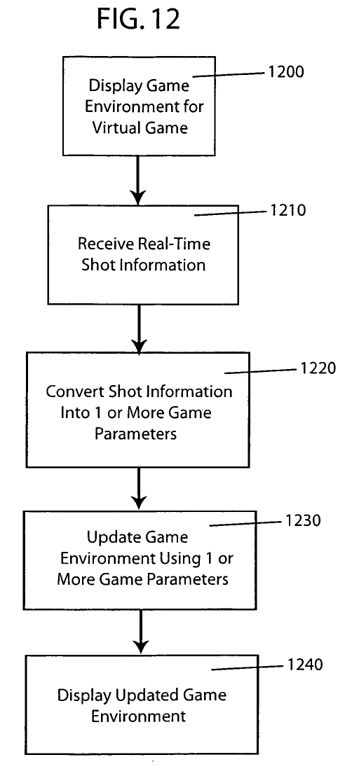

A preferred gaming method (which is independent of the exact game being played), is illustrated in FIG. 12. Particular games are provided by way of example in FIGS. 5-9. In any of these games, a player can compete against himself, against the computer, or against another player. At step S1200, a virtual game environment is first displayed to the golfer over the display 300 in his particular hitting area 455, 460, 465 in the driving range 400. The gaming software is preferably housed on the server/processor and may be created using any programming language and operating over any type of operating system. Alternatively, the software may be remotely located from, but accessible to the server/processor. The development of software programs generally for use with different computer operating systems is well known in the art. The game environment for use with the present invention may be a golf course for a golfing game, or it may be any of a variety of other types of games, such as a bull-eye, dartboard, or tic-tac-toe game.

After the golfer takes a golf shot from his hitting bay 455, 460, 465 on the driving range 400, at step S1210 real-time shot information on the golf shot is received from the trackable golf-ball 100 using the sensor 200 and the server/processor. This information preferably includes at least a shot trajectory and distance information. At step S1220, this shot information is converted into one or more parameters that can be used within the game being played. For example, if the game being played is a dartboard or bulls-eye game, the applicable game parameters might include a shot trajectory parameter, a first ball bounce parameter, and a final ball resting location parameter. Preferably, the parameter is of a format that can be used within the particular software type utilized for the game.

According to one aspect of the invention, the one or more game parameters may be further converted for use in a game provided over a separate and external computer or video game system. One type of game would be a golfing game for such a system. The golf game can match the look and feel of a standard golf computer game played on a game console such as the Sony PlayStation or Microsoft X-Box, or the better indoor golf simulators. In this way, rather than taking pretend shots in the golf game using a joystick or keypad, a golfer's actual shots on a driving range or golf course can be converted into shots usable within any of a variety of golf courses provided through the video game.

The in-game shot data may also be saved and later accessed (either in real-time or later) using a memory device incorporated within or connected to the server/processor. This data may also be accessed by a user over the Internet. In this way, stored games from a driving range can be accessed, watched and played at home.

At step S1230, the software utilizes the one or more game parameters within the game to update the game environment displayed to the golfer. Then, at step S1240 an updated game environment utilizing the game parameters is displayed to the golfer. For example, in the context of a dartboard or bulls-eye game described below, a new display illustrating the trajectory and location of the golf ball relative to the dartboard or bull-eye can be displayed. This process can continue until the player quits the game or until the game is completed.

Additionally, the virtual gaming system may include one or more telecommunications links. In this way, if different processors are contained in each hitting area of the driving range, one or more hitting areas can be linked together so that gofers can compete against one another. Also, the virtual gaming system may be connected to a remote location, such as through the Internet, so that golfers can compete against other competitors in different locations. For example, a golfer playing a virtual game at a driving range in New York can compete against another golfer playing at a driving range in London or Tokyo. Using the telecommunications link, a player's game parameters can be transmitter to any location around the world for use within a comparable virtual game system.

A more detailed example of display for a bulls-eye game is shown in FIG. 5. As shown, the display 300 illustrates a game environment 500 for the bulls-eye game. The display 300 includes a virtual bulls-eye target 525 whose layout generally corresponds to the driving range course 410. Additionally, according to another aspect of the invention, an actual bulls-eye target may be displayed on the course itself. This target may be painted on the course, it may be provided using lighting effects, or it may be provided using any of a variety of other known methods.

Once the target 525 is displayed to the player over the display 300, the player can take a shot using the trackable golf ball. The real-time shot information from the golf ball is received and converted into one or more game parameters usable within the bulls-eye game. For example, the shot information may include a three-dimensional shot trajectory 520, a first bounce position 530, a linear shot trajectory 510, and a final resting position 540. These parameters, in addition to other parameters, may be displayed over the display 300 in conjunction with the bulls-eye target 525. Scoring may occur in any of a variety of ways, such as by assigning various point values to correspond to various locations on the target 525, and then determining the achieved point value based on the initial bounce position 530 or the final resting position 540. A score 550 may then be displayed to the player over the display 300. A player can take one or more additional shots, competing against himself, the computer, or another player, either on the same course or on a remote course. The shot and/or scoring information may also be stored in an anonymous or personalized user data file.

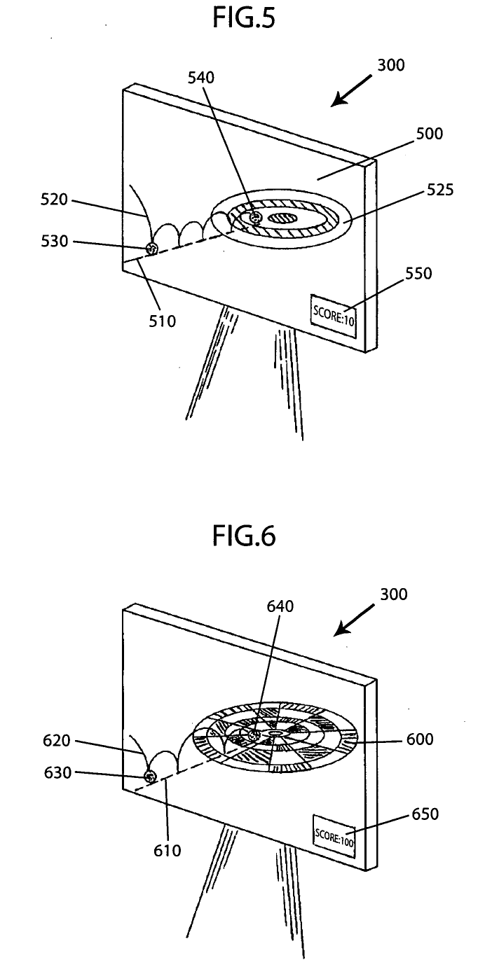

Similar to the bulls-eye game illustrated in FIG. 5 is a dartboard game, an example of which is shown in FIG. 6. This game is a slightly more complex version of the prior game and may follow standard dartboard rules and scoring using a dartboard grid 600 which is displayed over the display 300 and/or the course 410. In order to alter the level of difficulty of the game, the size of the grid 600 may be increased or decreased. Again, scoring may be based on the first strike location 630, the final resting location 640 or some other location. Once again, game parameters may include a first strike and resting location parameter 630, 640, a ball three-dimensional trajectory parameter 620, and a ball linear trajectory parameter 610. Additional parameters may also be utilized.

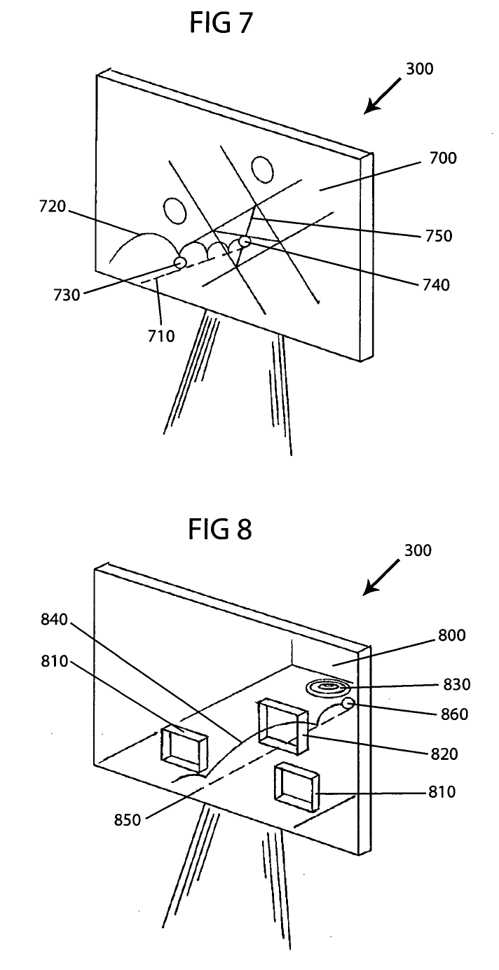

An example of a virtual tic-tac-toe (also known as ‘noughts and crosses’) game is shown in FIG. 7. In this game, the golfer attempts to accurately place his ball in a particular portion of the driving range. Each ball position can be mapped to a grid. The ball first strike (or final resting) position may be selected as the player's location choice for the game. For example, a standard grid 700 having nine locations may be displayed over the display 300 and/or the course 410. Depending on whether the first strike location 730 or the final resting location 740 is used, this location will be deemed to correspond to a box selected by the player. If the box has already been selected, the player may re-take the shot or, alternatively, may lose his turn. The player may compete against the computer or another golfer. As is typical with a tic-tac-toe game, the first player to start is assigned the “X” marker and the second player is assigned the “O” marker. The player alternates turns with the computer or the other player until someone has achieved three boxes in a row (either horizontal, vertical, or diagonal).

Yet another virtual game—called Hurdles and Hoops—is shown in FIG. 8. In this game, the golfer is challenged to make the golf ball pass through a series of three-dimensional obstacles. The obstacles may be virtual obstacles displayed only over the display 300 or they may also include physical obstacles actually placed out on the course 410. If physical obstacles are used, they will preferably be alternated so that different play environments are created. For example, one particular challenge might include placing the ball through a five meter separated path 810, inside a ten meter by ten meter box 820 and through a two meter round hoop 830. Another challenge might include placing the ball over a virtual hurdle twenty meters high and thirty meters away, without going higher than twenty-five meters. For this game, the real-time shot information and one or more game parameters preferably include at least a three-dimensional shot trajectory. Various point totals may be assigned based on the number of obstacles successfully achieved. Other scoring methods may alternatively be used. Once again, a player may compete against himself, against the computer, or against another player, either local or remotely located.

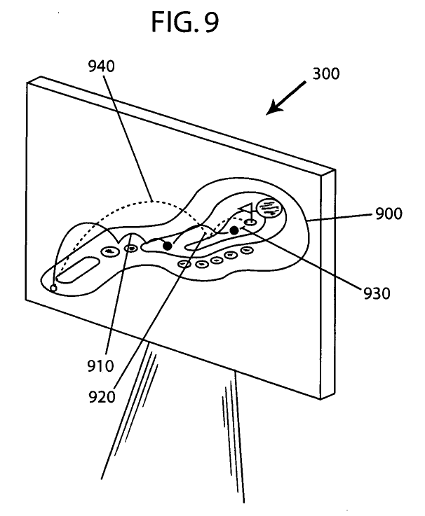

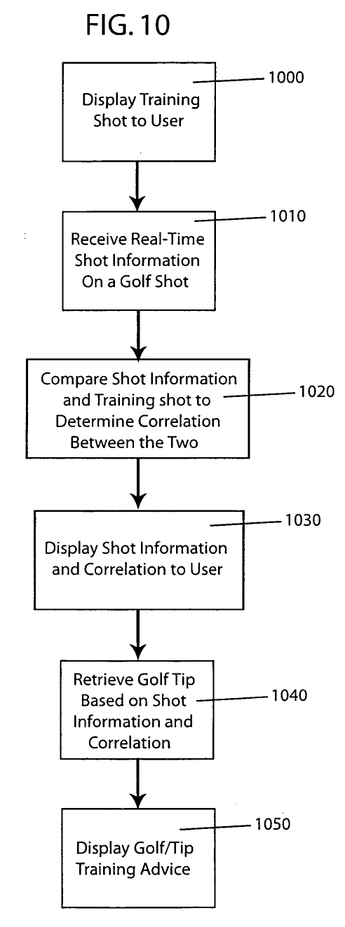

Yet another example of a virtual game is shown in FIG. 9. The game is a virtual golf game, which may be a golf game for the driving range, or it may be a golf game for an external computer or video game system. The golf game preferably includes virtual displays of actual golf courses. Preferably, different golf courses can be played by the player. This virtual golf game may operate like any computer golfing game on a PC or video game system, except that instead of using the keyboard or joystick to take simulated shots, the player actually hits the golf ball and the real-time shot information for the golf shot is converted into an corresponding shot on the displayed golf course. Preferably, the one or more game parameters include at least the ball trajectory and ball distance parameters. Other game parameters may include ball velocity, rolling distance, bouncing distance, number of bounces, spin rate, and the like. In playing the game, the player may again compete against the computer or other local or remotely located golfers. Additionally, the player may compete against an actual performance by a professional golfer, such as a Tiger Woods' performance on the same golf course.

In the virtual golf game, the display 300 preferably displays various holes on a golf course 900, the holes having a variety of features including a tee and a cup. After the player takes his shot on the driving range, the real-time shot information is preferably converted into one or more game parameters. The displayed parameters preferably include the shot trajectory 910. These parameters may then be displayed to the player over the display 300 in conjunction with the golf course 900. Then, the golfer may continue taking shots from the previous ball resting position until the ball reaches the cup. These subsequent shot trajectories 920, 930 are also preferably displayed to the player. If the player is competing against another opponent, the opponent's shot trajectories 940 are also preferably displayed. The players may alternate shots or each player may continue taking shots until the ball is in the cup for a given hole. Once a hole on the course is completed, the player may continue on to the next hole or the player may quit the game.

While the present invention has been described in connection with certain specific games, almost any type of virtual game may be utilized, provided that the real-time shot information can be converted into a meaningful game parameter usable within the game environment.

Virtual Training System and Method:

In addition to the gaming functions described above, the core technology can also enable a golfer to engage in a number of training activities while on a driving range or a golf course. These activities again leverage the system's ability to track a golf ball in flight and to associate the real-time information from the trackable golf ball with a particular location (and thereby golfer) on the driving range or golf course. A preferred training method is illustrated in FIG. 12.

At step S1000, a training program including one or more skill shots is displayed to the golfer on the display. The training program might be a consistency program which, for example, includes a particular shot which the golfer is to practice repeatedly in order to determine the golfer's consistency for this shot with respect to distance, speed, height, spin or other ball trajectory characteristics. The training program might alternatively be a shot matcher that includes certain obstacles that have to be met when matching the training shot. For example, a golfer could be challenged to match a series of drives in a Driving Shot Matcher, a golfer may be challenged to work on various types of approach shots in a Close Game Matcher or a golfer may be required to perform a variety of mixed shots in succession in an Obstacle Course Matcher. Alternatively, the training program might be a skill development program testing the golfer's ability to complete a series of shots, including thresholds of distance, accuracy, speed, spin, etc. Any of these programs can be custom designed by a golfer, golf course or driving range, or they can follow a standard common format. Further, a tutorial program may also be displayed to the golfer at this step, which tutorial program teaches various shot techniques. Instructions, including text, images, audio or video can be played on the display for the golfer.

Next, at step S1010, following the golfer's attempt to achieve a displayed training shot, various real-time shot information on the golf shot is received using the core equipment. This information may also include information that is calculated from the transmitted information using the server/processor. Additionally, if the system is equipped with an integral video camera, video of the golfer's swing and the shot trajectory can also be captured. At step S1020, the real-time shot information is compared to one or more characteristics of the training shot to determine a correlation between the two shots. For example, characteristics such as distance, spin, speed, trajectory, height, and acceleration of the golfer's shot and the training shot may be compared. Based on the extent of the correlation, various scoring or grading marks can be employed. For example, point totals can be awarded based on how close the training shot was to the actual golfer's shot.

At step S1030, the correlation and/or real-time shot information are displayed to the golfer on the display. This display may include textual information, as well as video and/or audio information. If an integral video camera is included, video playback of the swing may also be provided, which video may help a golfer self-diagnose various problems. At step S1040, additional training information or golf tips are retrieved based on the real-time shot information and the correlation. For example, if the golfer's actual shot trajectory indicates that the golfer's shot is a “push-slice” compared with the training shot, slicing and pushed shot advice may be retrieved. Alternatively, if the launch angle or shot velocity are less than those for the training shot, advice on stance and swing technique can be retrieved. In any event, at step S1050, any applicable training advice is displayed to the golfer on the display. Once again, this training advice may include text, as well as audio or video.

Subsequently, the real-time shot information, correlation information, and/or scoring information may be stored in a user data file associated with the particular golfer so that the golfer can access this information upon later visits. In this way, the golfer can track his performance and improvement over time.

While the invention has been described above with respect to certain embodiments thereof, it will be apparent to those skilled in the art that variations and modifications may be made without departing from the spirit and scope of the invention.

1. A method of providing training advice to a golfer who is using a trackable golf ball, comprising:
providing a training device which includes a receiver, a processor, a memory and a display;
displaying information concerning a training shot to the golfer using the display;
receiving real-time shot information at the receiver concerning a shot by the golfer using the trackable golf ball;
comparing the shot information and the training shot using the processor to determine a correlation between the shot information and the training shot; and
displaying the shot information together with the correlation to the golfer on the display.

2. The method of claim 1, further comprising determining a shot trajectory based on the shot information using the processor and displaying the trajectory to the golfer on the display.

3. The method of claim 2, further comprising comparing the shot trajectory with the training shot using the processor to determine the correlation.

4. The method of claim 1, wherein the training shot includes one or more of ball speed, ball acceleration, ball distance, ball height, ball spin, and ball trajectory.

5. The method of claim 1, wherein the training shot includes at least one of an actual shot by a professional golfer, a previous shot by the golfer and a shot by a competitor golfer.

6. The method of claim 1, wherein the training shot includes a plurality of training shots, and wherein the plurality of shots includes a plurality of shot types and a plurality of club types.

7. The method of claim 1, further comprising providing training advice to the golfer based on the correlation.

8. The method of claim 1, further comprising receiving an ultra-wideband signal.

9. The method of claim 1, further comprising determining an initial shot location for the golfer's shot using the processor based on the shot information.

10. The method of claim 9, where there are plural golfers each using respective trackable golf balls, the method further comprising determining an identity of the golfer based on the initial shot location.

11. The method of claim 1, further comprising:
receiving real-time information for a plurality of shots;
comparing the real-time information for the plurality of shots using the processor to determine a consistency value among the plurality of shots; and
displaying the consistency value to the golfer on the display.

12. The method of claim 1, further comprising determining a club type used for the golf shot and utilizing the club type to determine the correlation using the processor.

13. The method of claim 1, wherein the trackable golf ball further includes an embedded accelerometer, and wherein the receiver receives the real-time shot information for a discrete time period in response to a signal received from the accelerometer.

14. A method of employing real-time shot information on a golf shot hit by a golfer using a trackable golf ball within a virtual game, comprising:
providing a gaming system having a processor, a display and a receiver;
displaying a game environment for the virtual game to the golfer on the display;
receiving the real-time shot information concerning the golf shot using the receiver;
processing the shot information using the processor to determine one or more game parameters; and
utilizing the game parameters within the virtual game and updating the game environment based on the game parameters.

15. The method of claim 14, further comprising displaying the game environment on a driving range course.

16. The method of claim 14, wherein the gaming system further comprises a communications link, the method further comprising accessing one or more third party game parameters using the communications link and utilizing the third party game parameters within the virtual game.

17. The method of claim 14, further comprising converting the one or more game parameters to a format usable within an external gaming system and exporting the game parameters to the external gaming system.

18. The method of claim 17, wherein the external gaming system is one of a PC computer game, a Microsoft X-Box game, a Sony Playstation game or a Nintendo Gamecube game.

19. The method of claim 14, further comprising determining an initial shot location for the golfer's shot using the processor based on the shot information.

20. The method of claim 19, wherein there are plural gofers each using respective trackable golf balls, the method further comprising determining an identity of the golfer based on the initial shot location.

21. The method of claim 14, wherein the trackable golf ball further includes an embedded accelerometer, and wherein the receiver receives the real-time shot information for a discrete time period in response to a signal received from the accelerometer.

22. The method of claim 14, further comprising receiving an ultra-wideband signal.

23. The method of claim 14, wherein the virtual game is one of a bulls-eye game, a dartboard game, a tic-tac-toe game or a hurdles and hoops game.

24. The method of claim 23, wherein the real-time information includes one of a first strike location, a final resting location, or a trajectory for the golf ball.

25. The method of claim 24, further comprising determining a score based on the first strike location, the final resting location, or the trajectory using the processor and displaying the score to the golfer on the display.

26. A method of tracking an initial shot location of a golf shot made by a golfer at a driving range using a trackable golf ball, comprising:
providing a receiver, a processor coupled to the receiver, and a memory coupled to the processor, the memory further storing information on the driving range;
receiving real-time shot information transmitted from an ultra-wideband transmitter embedded in the golf ball using the receiver; and
comparing the shot information with the information on the driving range using the processor to determine the initial shot location.

27. The method of claim 26, wherein there are plural golfers each using respective trackable golf balls, the method further comprising determining the identity of the golfer based on the initial shot location.

28. The method of claim 26, further comprising analyzing the shot information and determining a trajectory of the golf shot using the processor, and determining the initial shot location based on the trajectory.

29. The method of claim 26, wherein the driving range information includes information on a plurality of hitting locations at the driving range.

30. The method of claim 26, further comprising storing the shot information and the trajectory in the memory and displaying one or more of the shot information and the trajectory using a display coupled to the processor.

31. A virtual golf gaming system which utilizes real-time shot information on a golf shot hit by a golfer, the system comprising:
a trackable golf ball having an embedded ultra-wideband transmitter for transmitting the shot information on the golf shot;
a receiver configured to receive the shot information in substantially real time;
a processor coupled to the receiver and configured to process the shot information to determine one or more game parameters for use within a virtual game, the virtual game stored within a memory connected to the processor, the processor further configured to provide at least an initial game environment for the virtual game and an updated game environment for the virtual game using the one or more game parameters; and
a display operatively coupled to the processor so as to display at least the initial game environment and the updated game environment.

32. The gaming system of claim 31, further comprising a communications link operatively coupled to the processor to receive third party game parameters.

33. The gaming system of claim 32, wherein the communication link includes a link to the Internet.

34. The gaming system of claim 32, wherein the processor is further configured to process the third party game parameters within the virtual game.

35. The gaming system of claim 31, wherein there are plural golfers each using respective trackable golf balls, and wherein the processor is further configured to determine the identity of the golfer based on the shot information.

36. The gaming system of claim 31, wherein the virtual game is one of a golfing game, a bulls-eye game, a dartboard game, a tic-tac-toe game or a hurdles and hoops game.

37. The gaming system of claim 31, wherein the trackable golf ball further includes an embedded accelerometer, and wherein the receiver receives the shot information for a discrete time period in response to a signal received from the accelerometer.

38. The gaming system of claim 31, wherein the processor is further configured to convert the one or more game parameters to a format usable by an external gaming system.

39. A virtual golf training system which utilizes real-time shot information on a golf shot hit by a golfer, the system comprising:
a trackable golf ball having an embedded ultra-wideband transmitter for transmitting the shot information on the golf shot;
a receiver configured to receive the shot information in substantially real time;
a processor coupled to the receiver and configured to provide one or more training shots, the one or more training shots stored within a memory connected to the processor, the processor further configured to compare the shot information and the one or more training shots to determine a correlation between the shot information and the one or more training shots; and
a display operatively coupled to the processor so as to display at least the one or more training shots, the shot information and the correlation.

40. The training system of claim 39, wherein the processor is further configured to determine a shot trajectory based on the shot display and wherein the display displays the shot trajectory.

41. The training system of claim 39, wherein there are plural golfers each using respective trackable golf balls, and wherein the processor is further configured to determine an initial shot location for the golf shot based on the shot information.

42. The training system of claim 41, wherein the processor is further configured to determine an identity of the golfer based on the initial shot location.

43. The training system of claim 39, wherein the processor is further configured to provide training advice to the golfer based on the correlation.

44. The training system of claim 39, wherein the training shot includes at least one of an actual shot by a professional golfer, a previous shot by the golfer and a shot by a competitor golfer.

45. The training system of claim 39, wherein the training shot includes a plurality of training shots, and wherein the plurality of shots includes a plurality of shot types and a plurality of club types.
